(19) United States
(12) Patent Application Publication
(10) Pub. No.: US 2004/0012641 A1
(43) Pub. Date: Jan. 22, 2004

(54) Performing default processes to produce three-dimensional data

(76) Inventor: Andre Gauthier, Quebec (CA)

Correspondence Address: HARNESS, DICKEY & PIERCE, P.L.C., P.O. BOX 828, BLOOMFIELD HILLS, MI, 48303, US

(21) Appl. No.: 10/314,011

(22) Filed: Dec. 6, 2002

(30) Foreign Application Priority Data
Jul. 19, 2002 (GB) 0216821.9

(51) Int. Cl. G09G 5/00

(52) U.S. Cl. 345/848

(57) ABSTRACT

Three dimensional data is generated, modified or animated within a computer base system. A representation of an existing 3D entity is displayed an a further entity is selected from a menu in response to manual operation of an input device. A user drags and drops the selected entity over the existing entity and the default operation is performed in order to create new data relevant to the entity association. If necessary a user is prompted for additional information when it is possible to perform more than one default operation.

### BACKGROUND OF THE INVENTION

1. Field of the Invention

The present invention relates to generating, modifying or animating three dimensional (3D) data using apparatus having processing means, storage means, visual display means and manually operable input means responsive to user defined positional data.

2. Description of the Related Art

Computerised systems for the generation of animation data have been used for some time. Increasingly, it is also being appreciated that three-dimensional animation techniques may be deployed in a wider range of environments, such as promotional, educational and customer interaction applications for example. In many of these applications, the emphasis is on providing a system that enhances the transfer of information, rather than on absolute artistic merit. Consequently there is a demand for systems that are capable of producing high quality results while demanding less skill on the part of an operator or artist. However, in order to produce convincing animations, many individual processes must be deployed and existing systems require significant skill on the part of operators and animation artists.

### BRIEF SUMMARY OF THE INVENTION

According to an aspect of the present invention, there is provided apparatus for generating modifying or animating three dimensional (3D) data, comprising processing means, storage means, visual display means and manually operable input means responsive to user defined positional data, wherein said display means displays representations of predefined animation related entities; entity selection data is received in response to manual operation of said input device wherein a first selected entity is associated with a second selected entity; said storage means includes a plurality of instructions for performing default processes in response to said association; and said processing means generates animation data by performing said default processes in respect of said associated entities.

In a preferred embodiment, the user is prompted to supply additional information after establishing an association before said 3D data is generated. The existing entity may be a scene and the selected entity may be a character. Alternatively, the existing entity may be a character or a three dimensional object and the selected entity may be a texture or an animation.

### BRIEF DESCRIPTION OF THE SEVERAL VIEWS OF THE DRAWINGS

FIG. 1 shows a storyboard on which an animation is to be based;

FIG. 2 shows an animation artist with a computer system;

FIG. 3 details the computer system shown in FIG. 2;

FIG. 4 details a directory structure on the hard drive shown in FIG. 3;

FIG. 5 summarises procedures performed by the CPU shown in FIG. 3;

FIG. 6 details procedures performed in FIG. 5;

FIG. 7 shows the display on the monitor illustrated in FIG. 2;

FIG. 8 illustrates the icon area shown in FIG. 7;

FIG. 9 illustrates the result of a first drag and drop;

FIG. 10 illustrates the result of a second drag and drop;

FIG. 11 illustrates the result of a third drag and drop;

FIG. 12 illustrates the result of a fourth drag and drop;

FIG. 13 illustrates the result of a fifth drag and drop;

FIG. 14 illustrates the result of a sixth drag and drop;

FIG. 15 illustrates the scene tree shown in FIG. 7;

FIG. 16 illustrates the result of a seventh drag and drop;

FIG. 17 illustrates the result of a eighth drag and drop;

FIG. 18 illustrates the result of a ninth drag and drop;

FIG. 19 illustrates the result of a tenth drag and drop;

FIG. 20 illustrates the result of a eleventh drag and drop; and

FIG. 21 illustrates the result of a twelfth drag and drop.

### WRITTEN DESCRIPTION OF THE BEST MODE FOR CARRYING OUT THE INVENTION

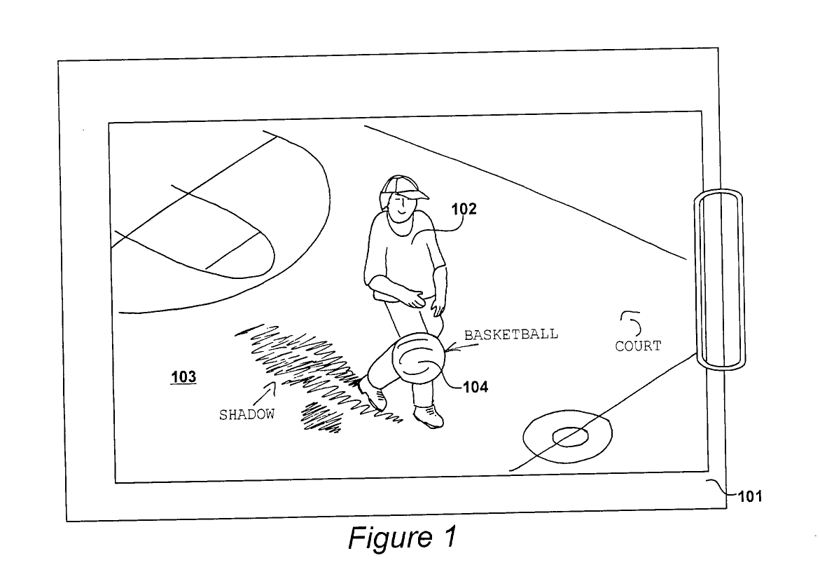

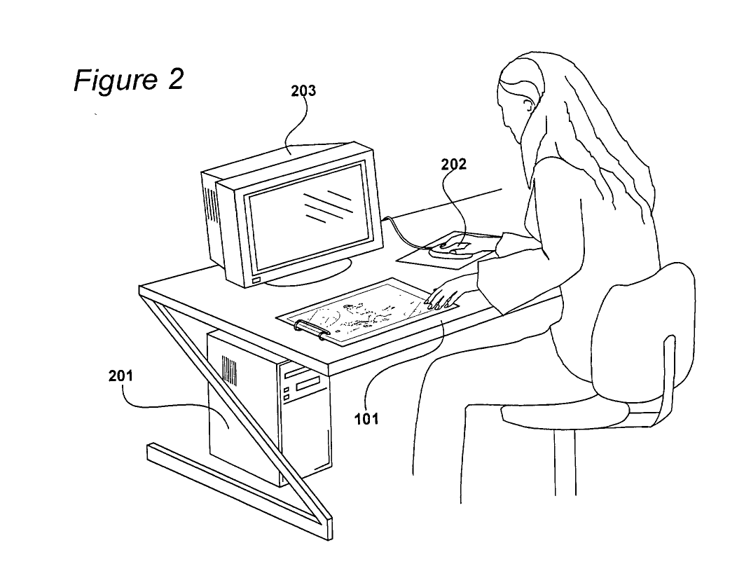

FIG. 1

A story board 101 for an animation is illustrated in FIG. 1. The story board will be given to an animator who will then produce the animation using computerised techniques.

A promotional animation is required in preference to recording live action. In this example, as a promotion for a new type of basketball a boy 102 is required to walk across a basketball court 103 bouncing a ball 104 while talking. The client does not require any sophisticated additional artistic input but the period for producing the promotional animation is very short.

FIG. 2

As shown in FIG. 2, storyboard 101 has been given to an animation artist equipped with a computer system 201. Input signals to the computer system 201 are received by manual operation of a mouse 202. Mouse 202 is operated in conjunction with a graphical user interface displayed on a visual display unit 203.

As an alternative to using a mouse 202, the artist could be provided with a stylus/touch-tablet combination, or a trackable or similar graphical input device.

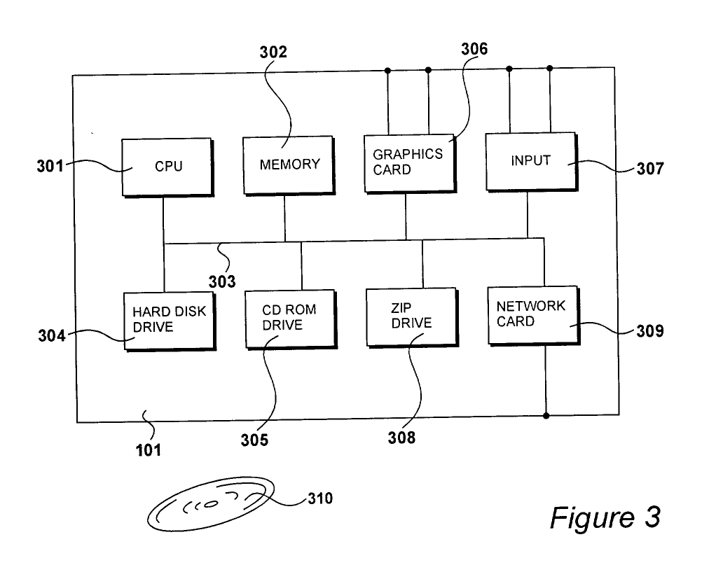

FIG. 3

Computer system 202 is detailed in FIG. 3. It includes a central processing unit 301 such as an Intel Pentium 4 processor or similar. Central processing unit 301 receives instructions from memory 302 via a system bus 303. On power-up, instructions are written to memory 302 from a hard disk drive 304. Programs are loaded to the hard disk drive 304 by means of a CD-ROM received within a CD ROM drive 305. Output signals to the display unit are supplied via a graphics card 306 and input signals from the mouse 202, similar devices and a keyboard are received via input card 307. The system also includes a zip drive 308 and a network card 309, each configured to facilitate the transfer of data into and out of the system.

The present invention is embodied by an animation program installed from a CD ROM 310 via the CD-ROM drive 305.

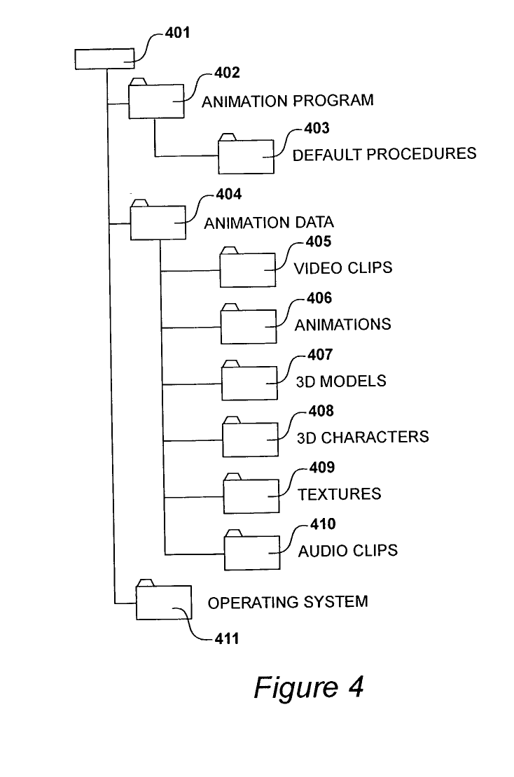

FIG. 4

The installation of the animation program from CD-ROM 310 onto hard disk drive 304 creates a directory structure on hard disk drive 304 as illustrated in FIG. 4. From a root directory 401, the animation program instructions are stored in subdirectory 402. Subdirectory 402 also includes a further subdirectory 403 for the storing of default procedures. The animation program stored in directory 402 is operable without the default procedures subdirectory 403. However, the provision of default procedures represents fundamental aspects of the preferred embodiment of the present invention in that they allow a relatively inexperienced animation artist to create high quality animations by providing a plurality of default situations.

A further directory 404 includes subdirectories, including a subdirectory 405 for video clips, a subdirectory 406 for animations, a subdirectory 407 for three-dimensional models, a subdirectory 408 for three-dimensional characters, a subdirectory 409 for textures and a subdirectory 410 for audio clips. These subdirectories may each include further subdirectories of their own as is common in this type of storage system. The structure also includes an operating system in a directory 411 that could be Linux or Windows etc.

Procedures for producing animation data may be considered as being assembled from a plurality of objects within an object-orientated environment. In addition, the three-dimensional animated scene itself may be considered as being made up from objects, this time representing real objects within the scene. In order to avoid confusion herein, the computer program type objects will be referred to as items. Thus, the creation of an item is akin to the instantiation of an object within an object-orientated environment. The created items are formed from the instantiation of a class and each of these classes, within a graphical user interface, is illustrated as an item class representation, preferably presented to the user as an icon.

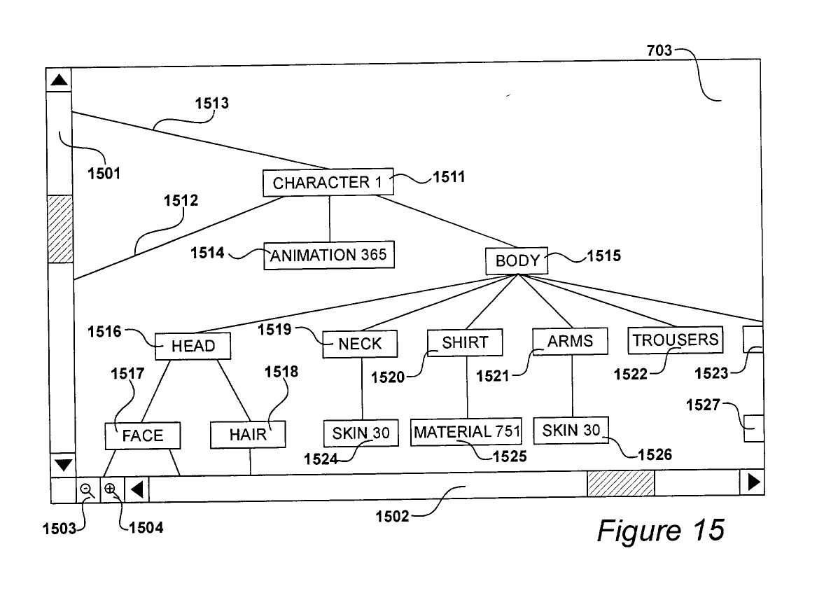

In the preferred embodiment a particular icon, being an item class representation, is selected using the mouse and then dragged into another area of the display. A drop may occur within the area such that a new item is created of the type defined by the item class. However in addition, in the preferred embodiment, it is possible for an item class representation to be dragged and dropped over an existing created item within a viewing area, and also for an existing created item to be dropped onto another existing created item. Created items and item class representations are referred to collectively herein as entities. Nodes within a scene tree are also entities, as will be described with reference to FIG. 15.

On detecting that an entity has been dropped on another entity the animation program interrogates a database of default procedures to determine whether a relevant procedure is available. At stages during the default procedure the user may be offered choices when two or more options appear to be equally possible. Alternatively, the default procedure may not involve any options and so the dragging and dropping process results in that procedure being performed automatically. In this way, as described in detail below, it is possible for users to create sophisticated animations quickly and with minimal background skill and knowledge of animation.

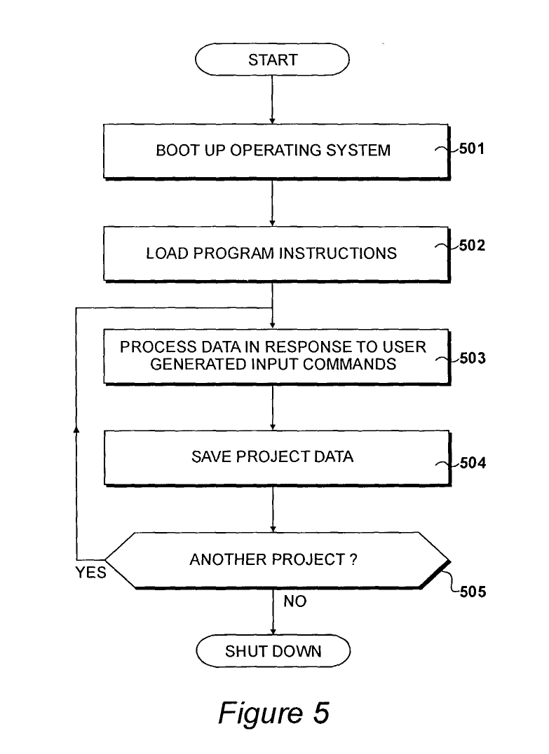

FIG. 5

Procedures performed by the central processing unit 301 in response to receiving animation program instructions for directory 402 are summarised in FIG. 5. After loading the operating system at step 501 animation program instructions are loaded at step 502. At step 503 data is processed in response to user generated input commands, generated primarily by mouse 202. After defining the animation at step 503 the project data is saved at step 504 and a question may be asked at step 505 as to whether another project is to be considered. If answered in the affirmative additional processing may occur with respect to another project at step 503. Alternatively, if answered in the negative the program is shut down.

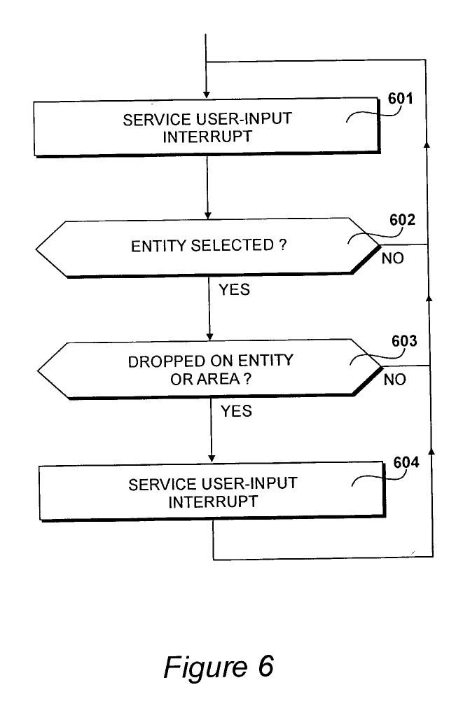

FIG. 6

The processing of data in response to user-generated input commands at step 503 allows many sophisticated animation techniques to be performed and often requires new program components to be loaded from the animation program directory 402, often involving entity creation from classes held in class libraries. A portion of the procedures performed, implementing the preferred embodiment of the present invention, is illustrated in FIG. 6. The processes are essentially event driven and will respond to event input data generated by the user. In order to respond to an event, central processing unit 301 will be responding to interrupts and the animation program, in combination with the operating system, will be required to handle these interrupts in an appropriate manner.

At step 601 a user generated input interrupt is serviced, possibly generated in response to a mouse button click or a stylus tip being placed in pressure. At step 602 a question is asked as to whether an entity, i.e. a created item, an item class representation or a scene tree node, has been selected, thereby raising the possibility of invoking procedures of the present preferred embodiment. If answered in the affirmative, a question is then asked at step 603 as to whether the entity has been dropped on another entity or in the viewer area of the display. If this question is also answered in the affirmative a default procedure is invoked at step 604. Very little further action is required on the part of the user in order to produce the required animated effect.

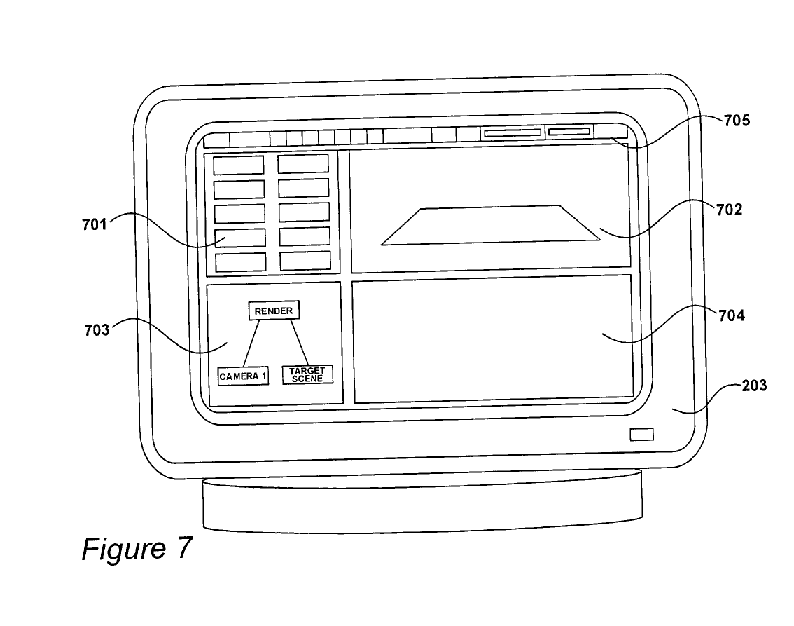

FIG. 7

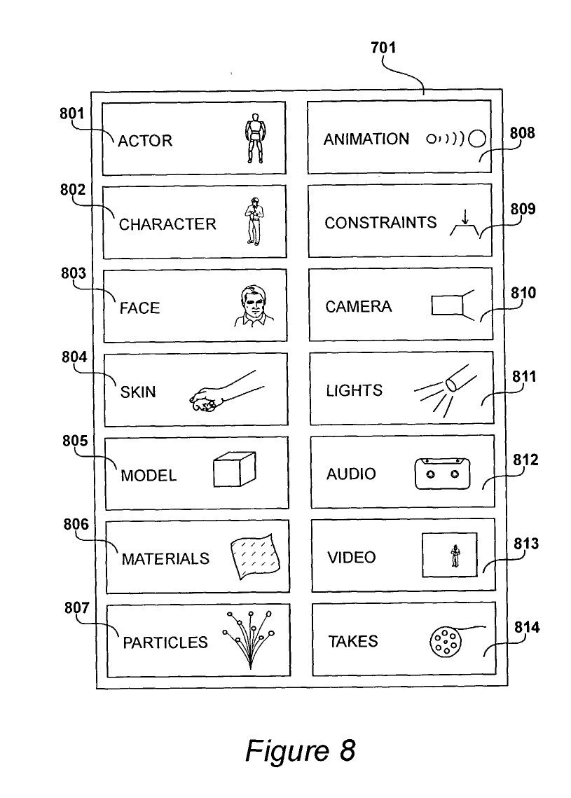

FIG. 7 illustrates the presentation of the animation program to the user. The display is split into four areas, icon area 701, viewer 702, scene tree 703 and tool area 704. Areas 701, 702 and 703 will be described more fully in FIGS. 8, 9 and 15 respectively. Currently viewer 702 contains only a virtual floor because no items have yet been created. Scene tree 703 contains information about every item within the viewer, represented by nodes connected by lines. Currently only the basic nodes (Renderer, Target Scene and Camera 1) are displayed, since the viewer is empty. When an item within viewer 702 is selected a relevant tool is displayed within tool area 704. This area is currently empty since there are no items to be selected.

The user may move a cursor across most of these areas by means of mouse 202 in order to create animation data using the drag and drop method. In addition, menu bar 705 is available for users who prefer not to use this method but to invoke the necessary procedures manually.

FIG. 8

FIG. 8 illustrates icon area 701. As previously described, each icon is an item class representation. Dragging an icon into viewer 702 results in a new item of the specified class being created, while dropping it over an existing created item within the viewer results in default procedures being carried out relevant to the selected icon and item.

Icon 801 represents the class of actors that may be mapped onto optical markers systems in order to be animated. Optical marker systems are created by attaching sensors or markers to a person and then capturing the motion data provided by these markers when the person moves around. By specifying which part of an actor matches with each marker the actor can be animated to move in the same way as the person.

Icon 802 represents the class of characters. These are graphical creations which include information such as the size and proportion of the body, face shape, clothes shape and colour and any items that the character may be carrying. Any character may be mapped onto an actor of a similar shape (for example, humanoid) in order that the character may be animated.

Icon 803 represents the class of facial constraints. These may be used to add a face to a character or another item and to animate the face.

Icon 804 represents the class of skin textures which may be applied to characters.

Icon 805 represents the class of models, which are objects that are not characters or actors. Examples of models are geometric shapes, such as cubes or spheres, natural objects such as trees and flowers, household objects such as chairs and tables, and so on. They could be referred to as inanimate objects but this is confusing, since within an animation program they may be animated. For example, the blowing of a tree in the wind is an animation.

Icon 806 represents the class of materials, these being any colour, texture or pattern which can be applied to any item.

Icon 807 represents the class of effects, such as particle effects.

Icon 808 represents the class of animation files which may be used to animate actors, characters or models.

Icon 809 represents the class of constraints. Constraints are applied to any item to prevent it moving or moving too far in a particular direction. For example, an actor's hand is constrained such that it can not be fully bent back along the arm.

Icon 810 represents the class of cameras. Any number of cameras may be placed within the viewer, and they may be visible or invisible to other cameras and may also be static or moving. A user can switch between camera views during a take in order to provide a more exciting feel.

Icon 811 represents the class of lights. An unlimited number of lights may be placed in the viewer in order that the items within may be lit in any conceivable way.

Icon 812 represents the class of audio files. These may be files containing speech that is to be spoken by characters, music to be used in the background or any other sort of audio file.

Icon 813 represents the class of video files which are two-dimensional moving images, such as might be filmed by a video camera or created by a graphics package. These may be used for example as a background in the viewer or as images playing on a television.

Icon 814 represents the class of takes, which are previously stored projects that may be inserted into the current project.

The item classes could be arranged in any way that makes sense within the animation program, and thus more or fewer icons may be used. The advantage of using fewer icons is that fewer default procedures need to be defined. The disadvantage of this, however, is that the user would have to make more choices during the procedures. Hence an optimal number of item classes and therefore of icons can be found.

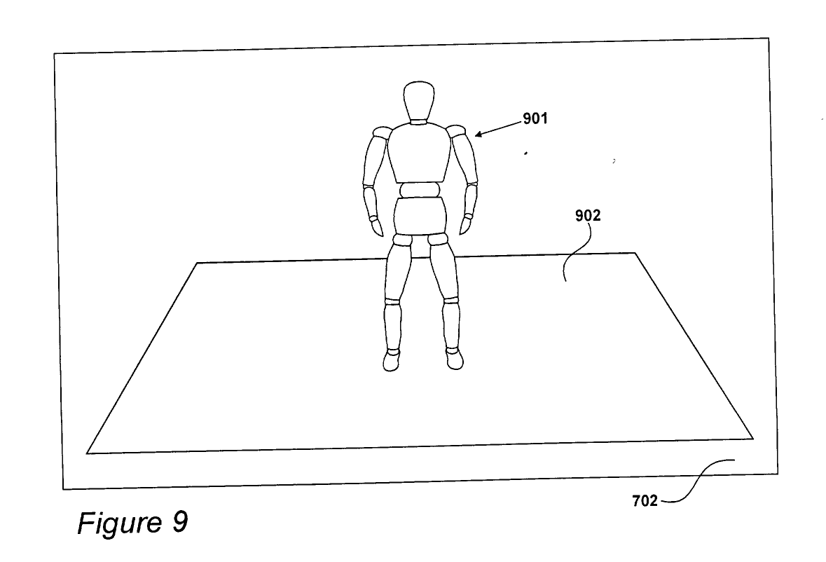

FIG. 9

To begin creating an animation, the user constructing the animation according to storyboard 101 clicks on icon 801 within icon area 701, drags it to viewer 702 and drops it there. The default procedure for the actor icon being dropped in the viewer is to create an actor within the viewer. FIG. 9 shows actor 901 standing on virtual floor 902. Viewer 702 is a two-dimensional representation of a three-dimensional space and so although the position of the mouse when dragging the icon could represent several positions within the three-dimensional space, the default procedure assumes that the user wishes the actor to stand on the floor and therefore interprets the two-dimensional mouse position accordingly. The default procedure then selects the actor within the viewer and displays the Actor tool within tool area 704. The Actor tool contains buttons and menus relevant to an actor. Thus the default procedure performs processes relevant to the selected entities and then directs the user to a relevant tool to fine-tune the choices made by the default procedure.

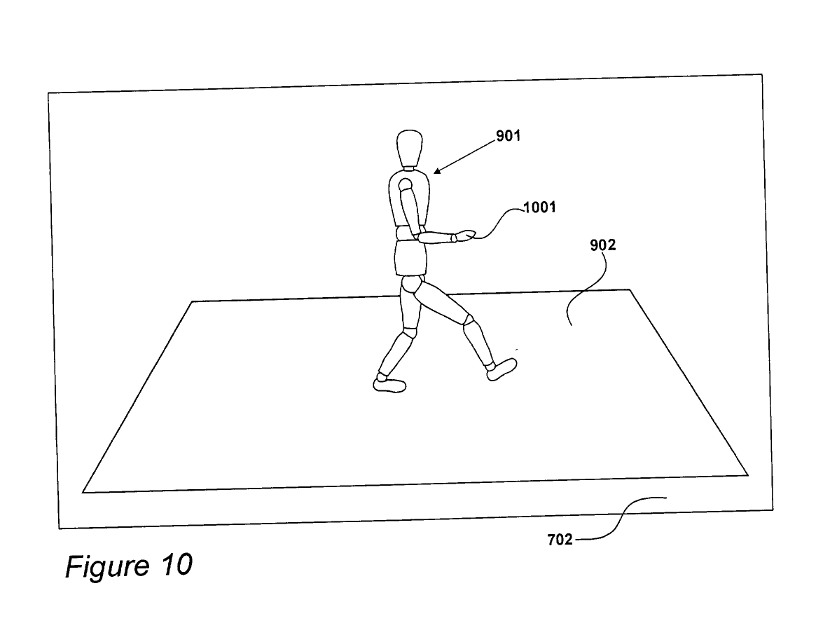

FIG. 10

The user next clicks on animation icon 807 and drags it onto actor 901 within viewer 702. The default procedure opens animation directory 406 and displays the animations therein that are suitable for an actor, thus relieving the user of the need to understand which animations can be used on which items. In this case the user selects “Walking while bouncing” which is then applied to actor 901. As can be seen in FIG. 10, actor 901 is now animated. The default procedure also automatically constrains the actor to the floor, so that he never appears to be stepping through it while walking.

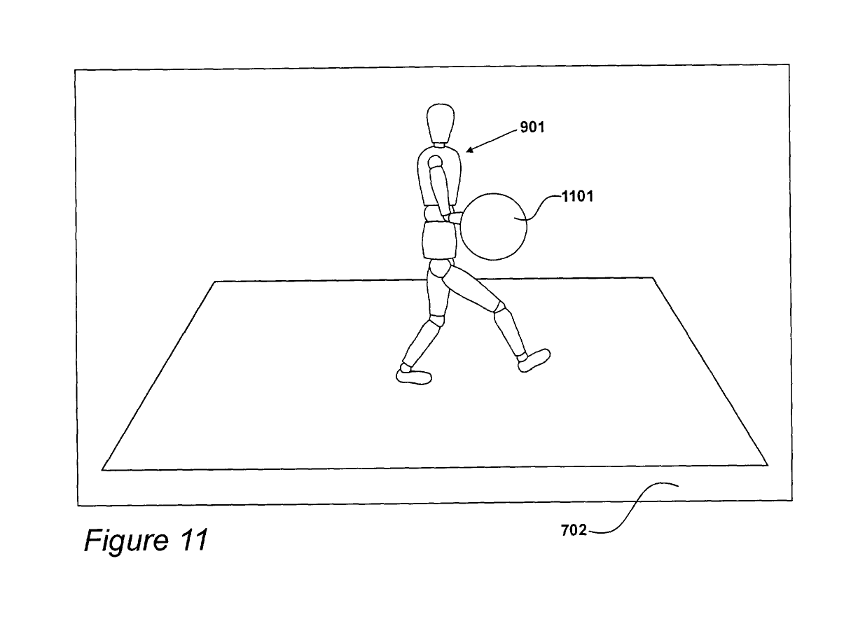

FIG. 11

The user next wishes to introduce a ball and so clicks on models icon 805, drags it into viewer 702 and drops it over the hand of actor 901. Firstly, the contents of 3-D models directory 407 is displayed to the user and the user selects a sphere. The default procedure then creates a sphere, places it in the viewer and constrains it to the appropriate item. However, an actor is made up of body parts and so it is equally logical to constrain the sphere to the particular body part selected, in this case the hand, as it is to constrain it to the entire actor. Thus, the user is presented with the choice of constraining the sphere to the hand or to the actor. The user chooses the hand and as shown in FIG. 11 sphere 1101 is constrained to the hand 1102 of actor 901. To produce this effect the default procedure searches through scene tree 703, which will be described in more detail with regard to FIG. 15, to find the hand of the actor and creates a parent-child constraint between the hand and the sphere respectively. The default procedure then selects the sphere and displays the Models tool within tools area 704.

The user now wishes sphere 1101 to bounce. He therefore clicks on animation icon 808, drags it into viewer 702 and drops it over sphere 1101. The default procedure opens animations directory 406 and displays the animations relevant to spheres. Note that when the same icon was dropped over an actor the animations relevant to actors were displayed. In this way the default procedures depend on both of the entities selected, and not just on one of them.

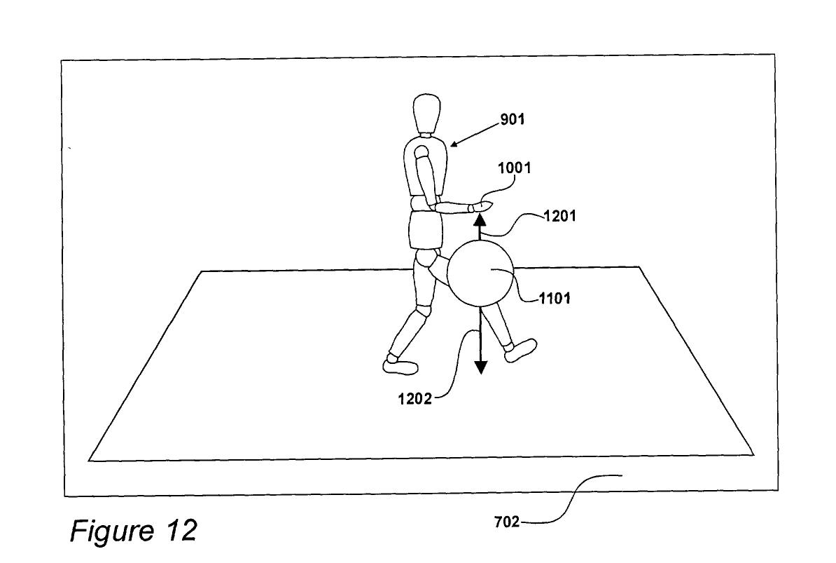

FIG. 12

The user selects “Fast bounce” and a bouncing animation is automatically added to the ball as shown in FIG. 12. Sphere 1101 is already constrained to hand 1102 and the default procedure constrains it to the ground. The default procedure also invokes the deformation properties of the sphere in order to make the animation more realistic when the ball hits the ground. Arrows 1201 and 1202 indicate the extent of the bounce.

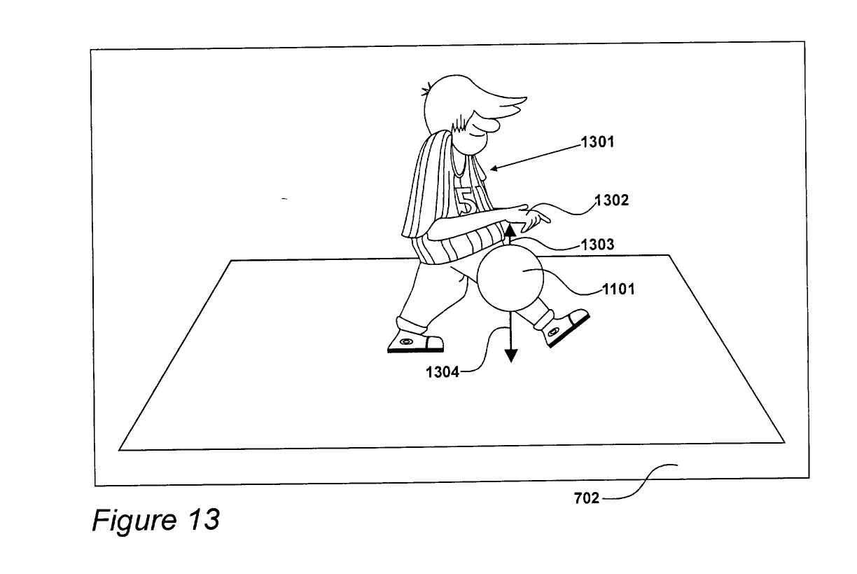

FIG. 13

Now that actor 901 and sphere 1101 are created and animated, the user can make them look like a basketball player and a basketball. Firstly, the user clicks on character icon 802, drags it into viewer 702 and drops it over actor 901. The default procedure opens 3-D characters directory 408 and displays the characters suitable to the actor. The user selects “Basketball cartoon boy” and the default procedure applies this character to actor 901, as shown in FIG. 13. Character 1301 is clearly of different proportions from actor 901, for example it has a larger body and longer forearms and the hand is closer to the ground than that of the actor. However, since ball 1101 is constrained to the character's hand 1302, along with the underlying actor's hand 1102, the ball is moved and the bounce constrained accordingly. The default procedure then selects the character and displays the Character tool within tool area 704.

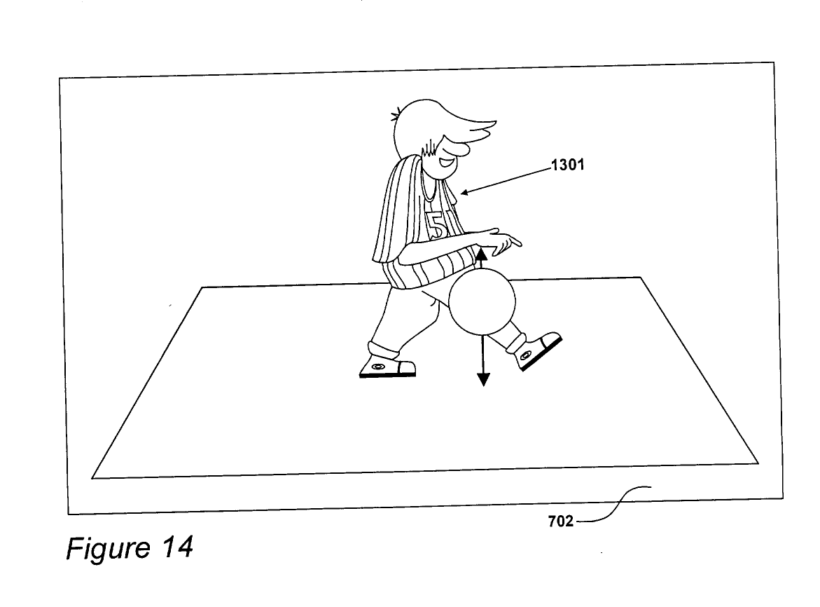

FIG. 14

The user now wishes to add speech to character 1301 so she clicks on audio icon 812, drags it into viewer 702 and drops it on the face of character 1301. The default procedure opens audio clips directory 410 and displays only the speech files, since other types of audio files cannot be applied to a face. The user selects the file named “Basketball advert”. The default procedure then opens a Voice Device tool within tool area 704 and assigns the audio clip to the face within this tool. As shown in FIG. 14, the face 1401 of character 1301 is now automatically animated to show the character speaking the words.

FIG. 15

The user now wishes to make the trousers of the character have the same pattern as his top. FIG. 15 illustrates scene tree 703 which is a graphical representation of all of the items and attributes shown within viewer 702. Typically, a scene tree can have thousands of nodes and so it is not possible to view the whole tree at once. Hence, scroll bars 1501 and 1502, zoom in button 1503 and zoom out button 1504 are used to navigate the scene tree. As shown in FIG. 15 a scene tree is made up of nodes connected by lines. A node indicates an item or an attribute and a line indicates a connection of some sort, for instance that an item has a certain attribute, that an item is constrained to another item and so on. Within the embodiment of the invention such nodes are considered to be entities, since they can be associated with created items in the viewer to invoke default procedures.

Node 1511 represents Character 1, i.e. basketball player 1301. Line 1512 leads out of the current view to the underlying skeleton of the actor, and line 1513 also leads out of view to the Target Scene node, which combines the information about all items shown within viewer 702.

Also connected to node 1511 is node 1514, representing the “Walking and bouncing” animation, and body node 1515. Leading off node 1515 are nodes representing each individual body part of the character. Node 1516 represents the character's head, which in turn is split into face node 1517 and hair node 1518. The attributes of these continue out of sight. Also attached to node 1515 is neck node 1519, shirt node 1520, arms node 1521, trousers node 1522 and shoes node 1523, which is just out of view. Most of these have a texture of some sort applied, as shown by nodes 1524, 1525, 1526 and 1527 respectively. As can be seen at node 1525, the shirt has material 761 applied to it. The trousers do not have a texture applied.

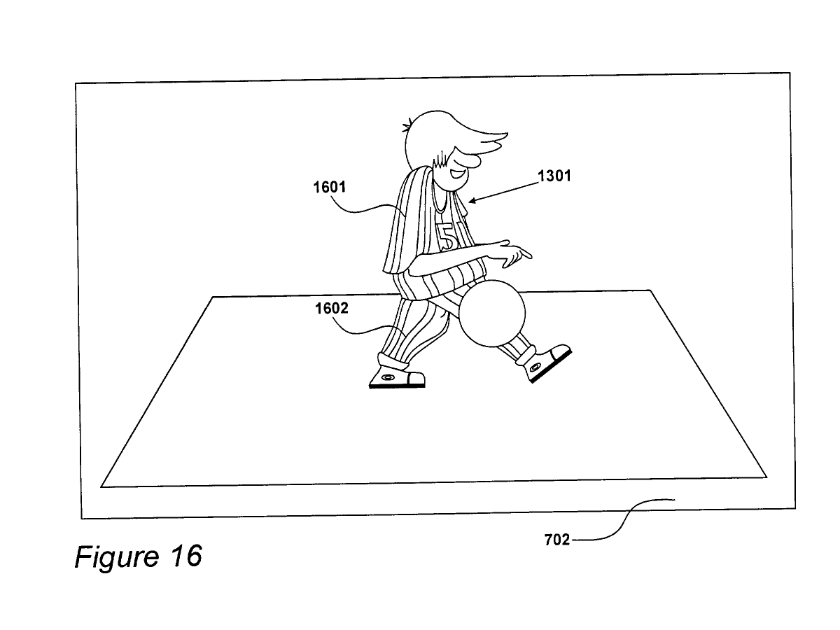

FIG. 16

The user now selects node 1525, drags it into viewer 702 and drops it on the character's trousers. Node 1525 remains within the scene tree but a default procedure is invoked by the drag and drop operation which creates a copy of node 1525 and constrains it to trousers node 1522. As shown in FIG. 16, within the viewer 702 the material providing the pattern on shirt 1601 is now the pattern on trousers 1602.

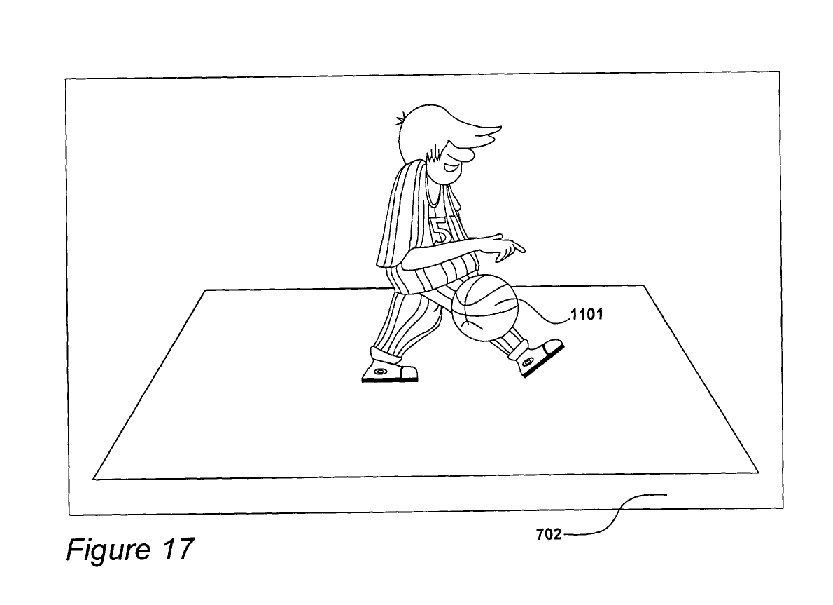

FIG. 17

The user now wishes to add a basketball pattern to sphere 1101. She therefore clicks on materials icon 806, drags it into viewer 702 and drops it on sphere 1101. The default procedure opens textures directory 409 and displays the contents, and the user selects one she considers suitable to a basketball. As shown in FIG. 17, this texture is then automatically wrapped around the sphere 1101 without any further action on her part. The default procedure then selects sphere 1101 and opens the Materials tool within tools area 704.

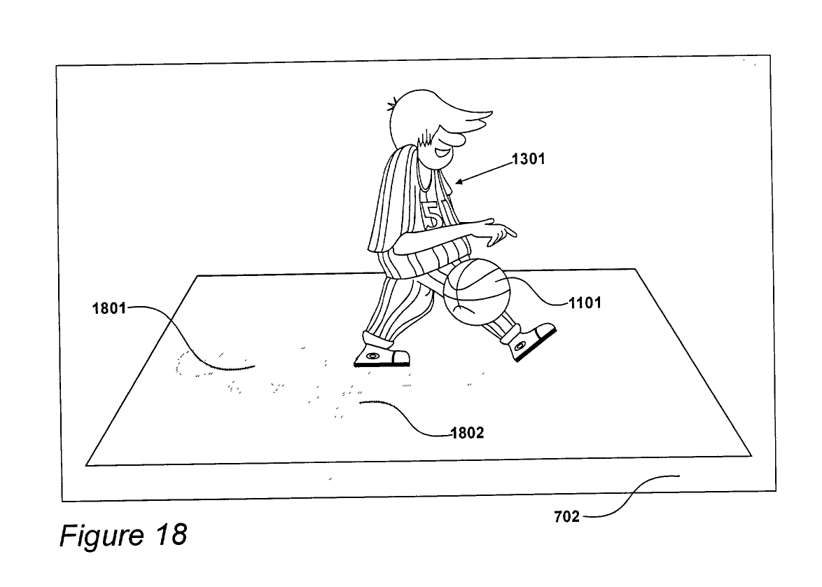

FIG. 18

Viewer 702 now contains a character walking and bouncing a basketball. Storyboard 101 indicates that this is taking place outside, and so the user wishes to add a strong light to represent the sun. She therefore clicks on lights icon 811, drags it into viewer 702 and drops it in the right hand corner. As shown in FIG. 18, this results in a shadow 1801 of character 1301 and another shadow 1802 of sphere 1101. The default procedure selects the light and opens the Lighting tool in tools area 704, which allows her to adjust the light's strength and position until she is satisfied.

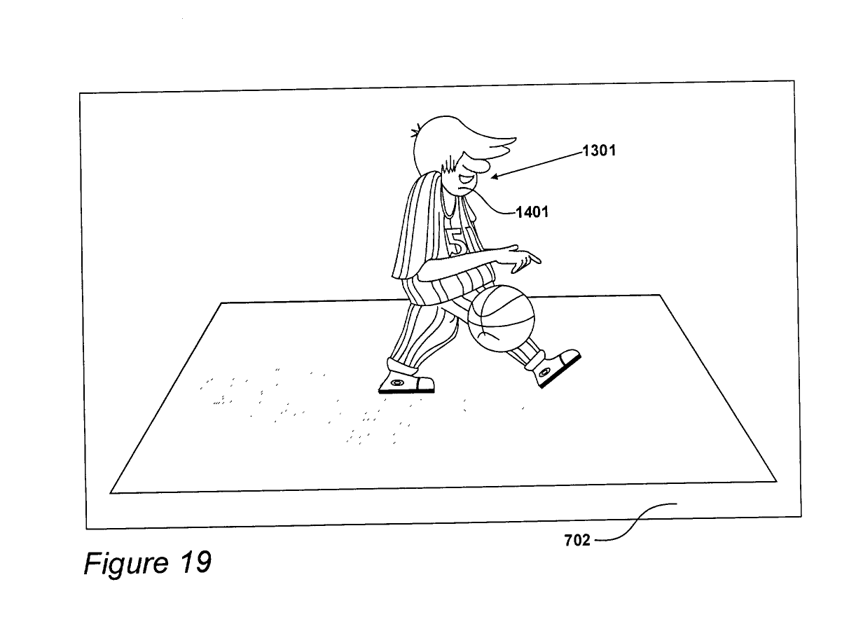

FIG. 19

Now that the basketball player is brightly lit, it becomes apparent that he is not as tanned as the figure shown in storyboard 101. The user therefore clicks on skin icon 804, drags it into viewer 702 and drops it on the face 1401 of character 1301. The default procedure prompts the user to make a choice between applying this skin only to the face 1401 or to all visible skin on character 1301. The user selects the second option and is then asked “Do you wish to replace the current skin?”. On answering this in the affirmative, the new skin texture is applied to all visible skin on the character. Since viewer 702 is a two-dimensional representation of a three-dimensional space, the default procedure also changes the skin colour on the left arm of character 1301, which cannot be seen by the user. The default procedure then opens the Skin tool within tools area 704, allowing the user to change the shade if required.

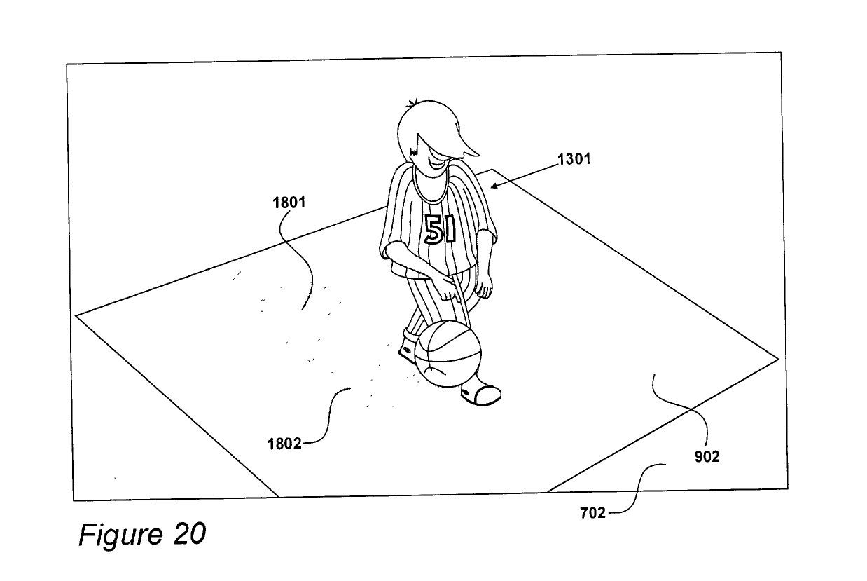

FIG. 20

Currently, character 1301 is walking from left to right along the screen. However storyboard 101 indicates that the character should be walking from the top left of the screen to the bottom right and so a different view is required. The user therefore clicks on camera icon 810, drags it into viewer 702 and drops it in the required position. The default procedure creates a new camera and places it in the position indicated. It then selects the camera as the current camera and as shown in FIG. 20 this results in a different view of floor 902 and character 1301, although shadows 1801 and 1802 are still cast directly behind the character since the light has not been moved. The default procedure then opens the camera tool, allowing the user to reposition the camera, zoom in and out and so on.

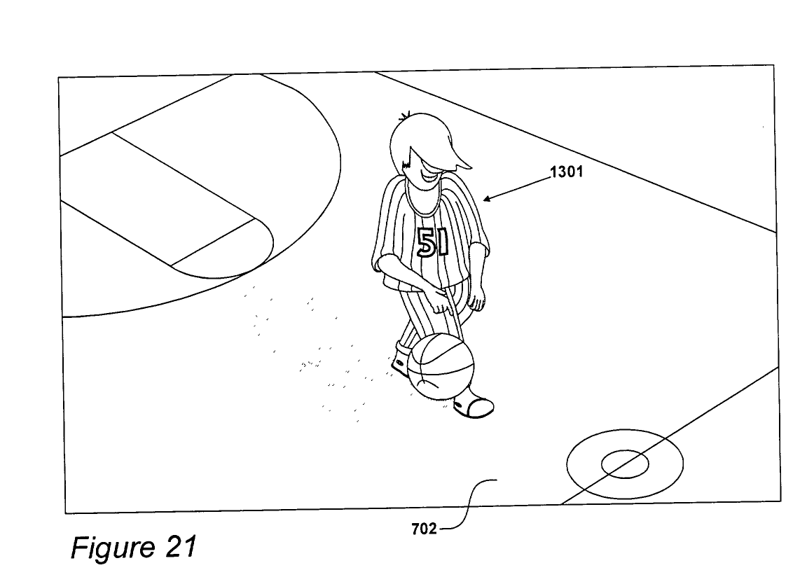

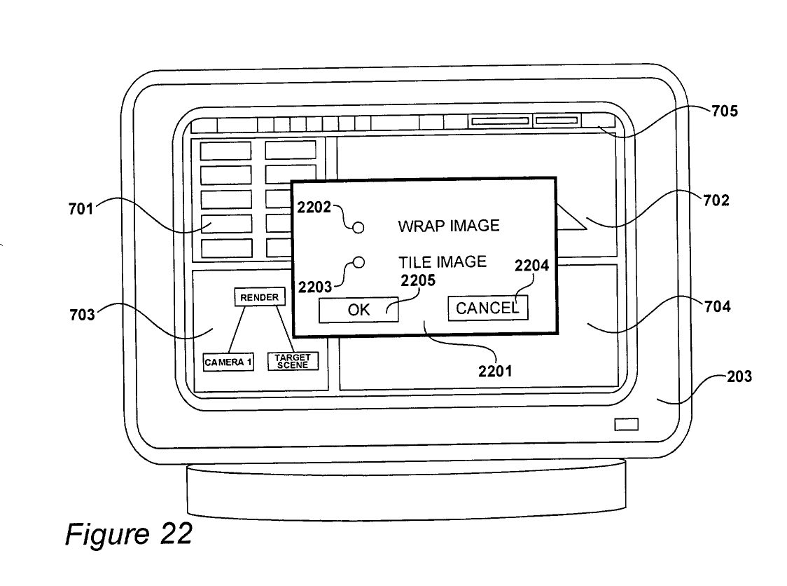

FIG. 21

Finally, the character should be walking on a basketball court. The user therefore clicks on materials icon 806, drags it into viewer 702 and drops it in a place not occupied by any item. The default procedure opens textures directory 409 and displays the contents of it to the user. The user selects “Basketball court” and the default procedure then applies it to the virtual floor. The default procedure then opens the Materials tool in viewer 702, allowing the user to enlarge the area covered by the texture. This results in viewer 702 displaying the animation as shown in FIG. 21.

The animation is now complete and can be saved and sent to the originator of storyboard 101.

FIG. 22

In some circumstances, it is possible for an entity to be selected an then associated with an existing entity whereupon default procedures are performed automatically given that there is sufficient information available in order to make a unique selection. However, in many situations several default procedures may be available and it is therefore necessary for a user to provide more information. An example of this would be a situation where a texture is to be applied to an existing three dimensional object. A texture is selected and then dragged and dropped onto the existing three dimensional object. Under these circumstances it is possible for the texture to be wrapped totally around the object or for the texture to be tiled repeatedly onto flat surfaces of the object. Thus, in response to an association of this type being defined, a user is invited to provide further information as illustrated in FIG. 22. Thus, in response to the association being defined, a question box 2201 is displayed over the existing image. the question box 2201 defines a first radio button 2202 and a second radio button 2203. By operation of the mouse 202, an operator provides additional information to the effect that the texture is to be wrapped totally around the object, by clicking on radio button 2202 or alternatively information is provided to the effect that the texture should be tiled by the selection of radio button 2203. It is possible for an operator to cancel the operation by mouse clicking on a cancel button 2204 or to confirm that operation by mouse clicking on an “OK” button 2205.

What is claimed is:

1. Apparatus for generating, modifying or animating three dimensional (3D) data, comprising processing means, storage means, visual display means and manually operable input means responsive to user defined positional data, wherein:
said display means displays representations of predefined 3D entities;
entity selection data is received in response to manual operation of said input device wherein a selected entity is associated with an existing entity;
said storage means includes a plurality of instructions for performing default processes in response to said association; and
said processing means generates 3D data by performing said default processes in respect of said associated entities.

2. Apparatus according to claim 1, wherein a user is prompted to supply additional information after establishing an association before said 3D data is generated.

3. Apparatus according to claim 1, wherein said existing entity is a scene and said selected entity is a character.

4. Apparatus according to claim 1, wherein said existing entity is a character or a three dimensional object and said selected entity is a texture or an animation.

5. Apparatus for generating, modifying or animating three dimensional (3D) data, comprising processing means, storage means, visual display means and manually operable input means responsive to user defined positional data, wherein:
said display means displays a representation of an existing 3D entity representing a character or a 3D object;
entity selection data is received in response to manual operation of said input device wherein a selected entity in the form of an animation or a texture is associated with an existing entity;
said storage means includes a plurality of instructions for performing default processes in response to said association; and
said processing means generates 3D data by performing said default processes in respect of said associated entities.

6. Apparatus for generating, modifying or animating three dimensional (3D) data, comprising processing means, storage means, visual display means and manually operable input means responsive to user defined positional data, wherein:
said display means displays a representation of an existing 3D entity representing a character or a 3D object;
entity selection data is received in response to manual operation of said input device wherein a selected entity in the form of an animation or a texture is associated with an existing entity;
said visual display means prompts a user to supply additional information after said association has been made;
said storage means includes a plurality of instructions for performing default processes for combining the existing entities with selected entities;
said processing means selects a default process in response to said association of the existing entity and the selected entity; and
said processing means generates 3D data by performing said default processes upon said associated entities.

7. Apparatus according to claim 1, wherein said first entity is associated with said second entity by said first entity being selected by said input device and being dragged and dropped on said second entity.

8. Apparatus for generating, or modifying or animating three dimensional (3D) data, comprising the steps of:
displaying representations of predefined D entities on visual display means;
receiving selection data in response to manual operation of an input device so as to associate a selected entity with an existing entity; and
generating 3D data by reading default instructions from storage means whereupon said default instructions are executed with respect to the associated entities.

9. A method according to claim 1, wherein a user is prompted to supply additional information after establishing an association before said 3D data is generated.

10. A method according to claim 8, wherein said existing entity is a scene and said selected entity is a character.

11. A method according to claim 8, wherein said existing entity is a character or a three dimensional object and said selected entity is a texture o an animation.

12. A method according to claim 8, wherein said first entities associated with said second entity by said first entity being selected by said input device and being dragged and dropped on said second entity.

13. A method for generating, modifying or animating three dimensional (3D) data, comprising the steps of:
displaying a representation of an existing 3D entity representing a character or a 3D objection on display means;
receiving entity selection data in response to manual operation of an input device wherein a selected entity is in the form of animation or a texture to be associated with an existing entity;
generating 3D data via performing a default operation read from storage means with respect to said associated entities.

14. A method for generating, modifying or animating three dimensional (3D) data, comprising the steps of:
displaying a representation of an existing 3D entity representing a character or a 3D objection on display means;
receiving entity selection data in response to manual operation of an input device wherein a selected entity is in the form of animation or a texture to be associated with an existing entity;
prompting a user to supply additional information via said visual display means after an association has been made; and
executing instructions read from storage means upon the selected entities and in response to said additional information so as to generate 3D data.
